(19) United States
(12) Patent Application Publication
(10) Pub. No.: US 2011/0111838 A1
(43) Pub. Date: May 12, 2011

(54) Thermal Management Systems For Wagering Game Terminals

(75) Inventors: Robert C. Bauer, Gurnee, IL (US); Charles R. Bleich, Cary, IL (US); Christopher W. Chudek, Evanston, IL (US); Christopher J. Lovelady, Chicago, IL (US); Eric T. Miner, Chicago, IL (US)

(73) Assignee: WMS Gaming Inc., Waukegan, IL (US)

(21) Appl. No.: 12/944,499

(22) Filed: Nov. 11, 2010

Related U.S. Application Data
(60) Provisional application No. 61/260,726, filed on Nov. 12, 2009.

(51) Int. Cl. G06F 17/00; F28D 15/00

(52) U.S. Cl. 463/25; 165/104.11

(57) ABSTRACT

According to one aspect of the present invention, a gaming terminal for playing a wagering game comprises a game cabinet containing an electronics component that is used in conjunction with the wagering game. The electronics component produces heat. An air duct is located within the cabinet. The air duct defines an air-flow passageway. The air duct has an intake port, an outtake port and at least one first vent between the intake port and the outtake port. The intake port is configured to receive air into the air duct and the outtake port is configured to exhaust air out of the game cabinet. The at least one vent receives air heated by the electronics component.

### REFERENCE TO RELATED APPLICATIONS

This application is related to and claims priority to U.S. Provisional Patent Application Ser. No. 61/260,726, filed Nov. 12, 2009, and titled “Thermal Management Systems For Wagering Game Terminals,” which is incorporated herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to wagering game terminals and, more particularly, to thermal management systems for wagering game terminals.

### BACKGROUND OF THE INVENTION

Gaming terminals, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing terminals and the expectation of winning each terminal is roughly the same (or believed to be the same), players are most likely to be attracted to the more entertaining and exciting terminal. As a result, wagering game terminal operators strive to employ the most entertaining and exciting terminals available, since such terminals attract frequent play and provide increased profitability for the operators. Consequently, wagering game terminals have added increasingly advanced and sophisticated features over the years in terms of their operational and display capabilities.

For example, modern gaming terminals typically include one or more power supplies, video displays, communication boards, currency acceptors, payoff mechanisms, card readers, sound systems, ticket printers and central processing units (CPUs). During extensive use, and due to the fact that many gaming terminals are always “on” even when not being played, the various components of the gaming terminal generate large amounts of heat such that some type of thermal management system is usually required to maintain the components within specified operating temperatures.

Prior art approaches to thermal management typically involve the use of fans to direct air onto the components of the gaming terminal or to direct air out of the gaming terminal cabinet through vents. As the sophistication of gaming terminals increases (e.g., greater processing power, display, and audio requirements), more efficient and effective thermal management systems are required.

### SUMMARY OF THE INVENTION

According to one aspect of the present invention, a gaming terminal for playing a wagering game comprises a game cabinet containing an electronics component that is used in conjunction with the wagering game. The electronics component produces heat. An air duct is located within the cabinet. The air duct defines an air-flow passageway. The air duct has an intake port, an outtake port and at least one first vent between the intake port and the outtake port. The intake port is configured to receive air into the air duct and the outtake port is configured to exhaust air out of the game cabinet. The at least one vent receives air heated by the electronics component.

According to another aspect of the present invention, a gaming terminal for playing a wagering game comprises a game cabinet. An interior wall within the cabinet divides the cabinet into a first chamber and a second chamber. The first chamber contains an electronics component that is used in conjunction with the wagering game. The electronics component produces heat. At least one thermoelectric assembly is disposed adjacent to the interior wall and is configured to transfer heat from the first chamber to the second chamber.

According to a further aspect of the present invention, a cabinet of a gaming machine is defined by a plurality of walls and a base floor. The cabinet includes an internal duct defining an air-flow passageway. A method of cooling electronics within a cabinet of a gaming machine comprises guiding warm air into a vent within the duct at a location above the base floor of the cabinet. The air duct defines an air-flow passageway that is shaped to substantially maintain the warm air within the air-flow passageway so as to not permit the warm air to re-enter a region adjacent the electronics within the cabinet. The method further comprises conveying the warm air upward within the air-flow passageway, exhausting the warm air from an upper portion of the cabinet and, while the warm air is exhausting from the cabinet, drawing ambient air that is cooler than the exhausted warm air into a lower portion of the cabinet.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a prior art free-standing gaming terminal.

FIG. 2 is a schematic view of a prior art gaming system.

FIG. 3 illustrates a thermal management system in a gaming terminal cabinet according to one embodiment of the present invention.

FIG. 4 illustrates a thermal management system in a gaming terminal cabinet according to another embodiment of the present invention.

FIG. 5 illustrates a thermal management system in a gaming terminal cabinet according to still another embodiment of the present invention.

FIG. 6 also illustrates a thermal management system in a gaming terminal cabinet according to the embodiment of FIG. 5.

FIG. 7 illustrates a water-resistant feature for a thermal management system according to one embodiment of the present invention

FIG. 8 illustrates a water-resistant feature for a thermal management system according to another embodiment of the present invention.

FIG. 9 illustrates a water-resistant feature for a thermal management system according to still another embodiment of the present invention.

FIGS. 10A-C illustrate a side view, a rear view and a top view, respectively, of a thermal management system according to an alternative embodiment of the present invention.

FIGS. 11A-B illustrate a thermoelectric cooling assembly and a gaming terminal component.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

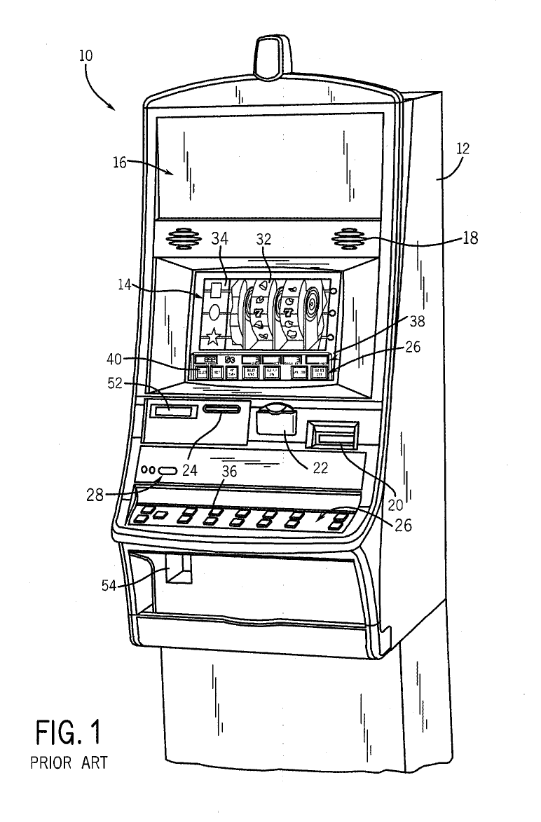

Referring to FIG. 1, there is shown a gaming terminal 10 similar to those used in gaming establishments, such as casinos. With regard to the present invention, the gaming terminal 10 may be any type of gaming terminal and may have varying structures and methods of operation. For example, in some aspects, the gaming terminal 10 is be an electromechanical gaming terminal configured to play mechanical slots, whereas in other aspects, the gaming terminal is an electronic gaming terminal configured to play a video casino game, such as slots, keno, poker, blackjack, roulette, craps, etc. It should be understood that although the gaming terminal 10 is shown as a free-standing terminal of the upright type, the gaming terminal is readily amenable to implementation in a wide variety of other forms such as a free-standing terminal of the slant-top type.

The gaming terminal 10 illustrated in FIG. 1 comprises a cabinet or housing 12. For output devices, this embodiment of the gaming terminal 10 includes a primary display area 14, a secondary display area 16, and one or more audio speakers 18. The primary display area 14 and/or secondary display area 16 variously displays information associated with wagering games, non-wagering games, community games, progressives, advertisements, services, premium entertainment, text messaging, emails, alerts or announcements, broadcast information, subscription information, etc. appropriate to the particular mode(s) of operation of the gaming terminal. For input devices, the gaming terminal 10 illustrated in FIG. 1 includes a bill validator 20, a coin acceptor 22, one or more information readers 24, one or more player-input devices 26, and one or more player-accessible ports 28 (e.g., an audio output jack for headphones, a video headset jack, a wireless transmitter/receiver, etc.). While these typical components found in the gaming terminal 10 are described below, it should be understood that numerous other peripheral devices and other elements exist and are readily utilizable in any number of combinations to create various forms of a gaming terminal in accord with the present invention.

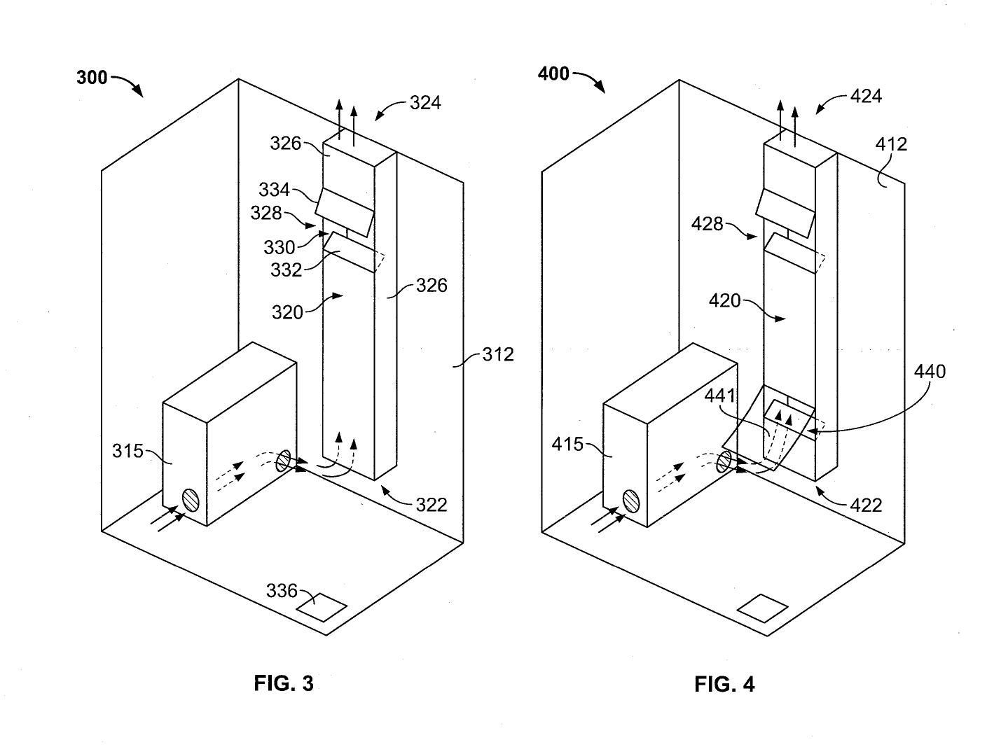

The primary display area 14 include, in various aspects of the present invention, a mechanical-reel display, a video display, or a combination thereof in which a transmissive video display is disposed in front of the mechanical-reel display to portray a video image in superposition over the mechanical-reel display. Further information concerning the latter construction is disclosed in U.S. Pat. No. 6,517,433 to Loose et al. entitled “Reel Spinning Slot Machine With Superimposed Video Image,” which is incorporated herein by reference in its entirety. The video display is, in various embodiments, a cathode ray tube (CRT), a high-resolution liquid crystal display (LCD), a plasma display, a light emitting diode (LED), a DLP projection display, an electroluminescent (EL) panel, or any other type of display suitable for use in the gaming terminal 10, or other form factor, such as is shown by way of example in FIG. 1. The primary display area 14 includes, in relation to many aspects of wagering games conducted on the gaming terminal 10, one or more paylines 30 (see FIG. 3) extending along a portion of the primary display area. In the illustrated embodiment of FIG. 1, the primary display area 14 comprises a plurality of mechanical reels 32 and a video display 34, such as a transmissive display (or a reflected image arrangement in other embodiments), in front of the mechanical reels 32. If the wagering game conducted via the gaming terminal 10 relies upon the video display 34 only and not the mechanical reels 32, the mechanical reels 32 are optionally removed from the interior of the terminal and the video display 34 is advantageously of a non-transmissive type. Similarly, if the wagering game conducted via the gaming terminal 10 relies only upon the mechanical reels 32, but not the video display 34, the video display 34 depicted in FIG. 1 is replaced with a conventional glass panel. Further, in still other embodiments, the video display 34 is disposed to overlay another video display, rather than a mechanical-reel display, such that the primary display area 14 includes layered or superimposed video displays. In yet other embodiments, the mechanical-reel display of the above-noted embodiments is replaced with another mechanical or physical member or members such as, but not limited to, a mechanical wheel (e.g., a roulette game), dice, a pachinko board, or a diorama presenting a three-dimensional model of a game environment.

Video images in the primary display area 14 and/or the secondary display area 16 are rendered in two-dimensional (e.g., using Flash Macromedia™) or three-dimensional graphics (e.g., using Renderware™). In various aspects, the video images are played back (e.g., from a recording stored on the gaming terminal 10), streamed (e.g., from a gaming network), or received as a TV signal (e.g., either broadcast or via cable) and such images can take different forms, such as animated images, computer-generated images, or “real-life” images, either prerecorded (e.g., in the case of marketing/promotional material) or as live footage. The format of the video images can include any format including, but not limited to, an analog format, a standard digital format, or a high-definition (HD) digital format.

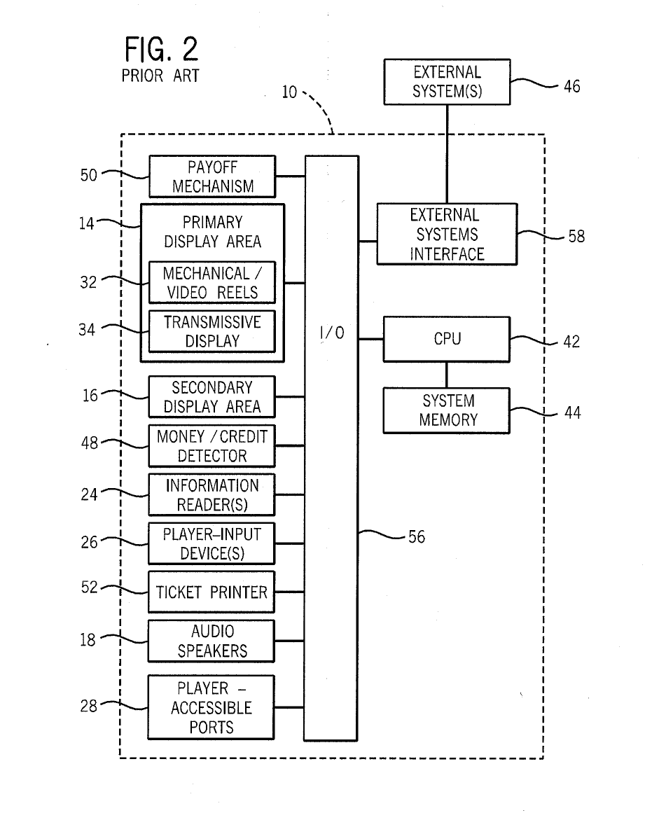

The player-input or user-input device(s) 26 include, by way of example, a plurality of buttons 36 on a button panel, as shown in FIG. 1, a mouse, a joy stick, a switch, a microphone, and/or a touch screen 38 mounted over the primary display area 14 and/or the secondary display area 16 and having one or more soft touch keys 40, as is also shown in FIG. 1. In still other aspects, the player-input devices 26 comprise technologies that do not rely upon physical contact between the player and the gaming terminal, such as speech-recognition technology, gesture-sensing technology, eye-tracking technology, etc. The player-input or user-input device(s) 26 thus accept(s) player input(s) and transforms the player input(s) to electronic data signals indicative of a player input or inputs corresponding to an enabled feature for such input(s) at a time of activation (e.g., pressing a “Max Bet” button or soft key to indicate a player's desire to place a maximum wager to play the wagering game). The input(s), once transformed into electronic data signals, are output to a CPU or controller 42 (see FIG. 2) for processing. The electronic data signals are selected from a group consisting essentially of an electrical current, an electrical voltage, an electrical charge, an optical signal, an optical element, a magnetic signal, and a magnetic element.

The information reader 24 (or information reader/writer) is preferably located on the front of the cabinet 12 and comprises, in at least some forms, a ticket reader, card reader, bar code scanner, wireless transceiver (e.g., RFID, Bluetooth, etc.), biometric reader, or computer-readable-storage-medium interface. As noted, the information reader may comprise a physical and/or electronic writing element to permit writing to a ticket, a card, or computer-readable-storage-medium. The information reader 24 permits information to be transmitted from a portable medium (e.g., ticket, voucher, coupon, casino card, smart card, debit card, credit card, etc.) to the information reader 24 to enable the gaming terminal 10 or associated external system to access an account associated with cashless gaming, to facilitate player tracking or game customization, to retrieve a saved-game state, to store a current-game state, to cause data transfer, and/or to facilitate access to casino services, such as is more fully disclosed, by way of example, in U.S. Patent Publication No. 2003/0045354 entitled “Portable Data Unit for Communicating With Gaming Machine Over Wireless Link,” which is incorporated herein by reference in its entirety. The noted account associated with cashless gaming is, in some aspects of the present invention, stored at an external system 46 (see FIG. 2) as more fully disclosed in U.S. Pat. No. 6,280,328 to Holch et al. entitled “Cashless Computerized Video Game System and Method,” which is incorporated herein by reference in its entirety, or is alternatively stored directly on the portable storage medium. Various security protocols or features can be used to enhance security of the portable storage medium. For example, in some aspects, the individual carrying the portable storage medium is required to enter a secondary independent authenticator (e.g., password, PIN number, biometric, etc.) to access the account stored on the portable storage medium.

Turning now to FIG. 2, the various components of the gaming terminal 10 are controlled by one or more processors (e.g., CPU, distributed processors, etc.) 42, also referred to herein generally as a controller (e.g., microcontroller, microprocessor, etc.). The controller 42 can include any suitable processor(s), such as an Intel® Pentium processor, Intel® Core 2 Duo processor, AMD Opteron™ processor, or UltraSPARC® processor. By way of example, the controller 42 includes a plurality of microprocessors including a master processor, a slave processor, and a secondary or parallel processor. Controller 42, as used herein, comprises any combination of hardware, software, and/or firmware disposed in and/or disposed outside of the gaming terminal 10 that is configured to communicate with and/or control the transfer of data between the gaming terminal 10 and a bus, another computer, processor, or device and/or a service and/or a network. The controller 42 comprises one or more controllers or processors and such one or more controllers or processors need not be disposed proximal to one another and may be located in different devices and/or in different locations. For example, a first processor is disposed proximate a user interface device (e.g., a push button panel, a touch screen display, etc.) and a second processor is disposed remotely from the first processor, the first and second processors being electrically connected through a network. As another example, the first processor is disposed in a first enclosure (e.g., a gaming machine) and a second processor is disposed in a second enclosure (e.g., a server) separate from the first enclosure, the first and second processors being communicatively connected through a network. The controller 42 is operable to execute all of the various gaming methods and other processes disclosed herein.

To provide gaming functions, the controller 42 executes one or more game programs comprising machine-executable instructions stored in local and/or remote computer-readable data storage media (e.g., memory 44 or other suitable storage device). The term computer-readable data storage media, or “computer-readable medium,” as used herein refers to any media/medium that participates in providing instructions to controller 42 for execution. The computer-readable medium comprises, in at least some exemplary forms, non-volatile media (e.g., optical disks, magnetic disks, etc.), volatile media (e.g., dynamic memory, RAM), and transmission media (e.g., coaxial cables, copper wire, fiber optics, radio frequency (RF) data communication, infrared (IR) data communication, etc). Common forms of computer-readable media include, for example, a hard disk, magnetic tape (or other magnetic medium), a 2-D or 3-D optical disc (e.g., a CD-ROM, DVD, etc.), RAM, PROM, EPROM, FLASH-EPROM, any other memory chip or solid state digital data storage device, a carrier wave, or any other medium from which a computer can read. By way of example, a plurality of storage media or devices are provided, a first storage device being disposed proximate the user interface device and a second storage device being disposed remotely from the first storage device, wherein a network is connected intermediate the first one and second one of the storage devices.

Various forms of computer-readable media may be involved in carrying one or more sequences of one or more instructions to controller 42 for execution. By way of example, the instructions may initially be borne on a data storage device of a remote device (e.g., a remote computer, server, or system). The remote device can load the instructions into its dynamic memory and send the instructions over a telephone line or other communication path using a modem or other communication device appropriate to the communication path. A modem or other communication device local to the gaming machine 10 or to an external system 46 associated with the gaming machine can receive the data on the telephone line or conveyed through the communication path (e.g., via external systems interface 58) and output the data to a bus, which transmits the data to the system memory 44 associated with the processor 42, from which system memory the processor retrieves and executes the instructions.

Thus, the controller 42 is able to send and receive data, via carrier signals, through the network(s), network link, and communication interface. The data includes, in various examples, instructions, commands, program code, player data, and game data. As to the game data, in at least some aspects of the present invention, the controller 42 uses a local random number generator (RNG) to randomly generate a wagering game outcome from a plurality of possible outcomes. Alternatively, the outcome is centrally determined using either an RNG or pooling scheme at a remote controller included, for example, within the external system 46.

As shown in the example of FIG. 2, the controller 42 is coupled to the system memory 44. The system memory 44 is shown to comprise a volatile memory (e.g., a random-access memory (RAM)) and a non-volatile memory (e.g., an EEPROM), but optionally includes multiple RAM and multiple program memories.

As shown in the example of FIG. 2, the controller 42 is also coupled to a money/credit detector 48. The money/credit detector 48 is configured to output a signal to the controller 42 that money and/or credits have been input via one or more value-input devices, such as the bill validator 20, coin acceptor 22, or via other sources, such as a cashless gaming account, etc. The value-input device(s) is integrated with the cabinet 12 of the gaming terminal 10 and is connected to the remainder of the components of the gaming terminal 10, as appropriate, via a wired connection, such as I/O 56, or wireless connection. The money/credit detector 48 detects the input of valid funds into the gaming terminal 10 (e.g., via currency, electronic funds, ticket, card, etc.) via the value-input device(s) and outputs a signal to the controller 42 carrying data regarding the input value of the valid funds. The controller 42 extracts the data from these signals from the money/credit detector 48, analyzes the associated data, and transforms the data corresponding to the input value into an equivalent credit balance that is available to the player for subsequent wagers on the gaming terminal 10, such transforming of the data being effected by software, hardware, and/or firmware configured to associate the input value to an equivalent credit value. Where the input value is already in a credit value form, such as in a cashless gaming account having stored therein a credit value, the wager is simply deducted from the available credit balance.

As seen in FIG. 2, the controller 42 is also connected to, and controls, the primary display area 14, the player-input device(s) 26, and a payoff mechanism 50. The payoff mechanism 50 is operable in response to instructions from the controller 42 to award a payoff to the player in response to certain winning outcomes that occur in the base game, the bonus game(s), or via an external game or event. The payoff is provided in the form of money, credits, redeemable points, advancement within a game, access to special features within a game, services, another exchangeable media, or any combination thereof. Although payoffs may be paid out in coins and/or currency bills, payoffs are alternatively associated with a coded ticket (from a ticket printer 52), a portable storage medium or device (e.g., a card magnetic strip), or are transferred to or transmitted to a designated player account. The payoff amounts distributed by the payoff mechanism 50 are determined by one or more pay tables stored in the system memory 44.

Communications between the controller 42 and both the peripheral components of the gaming terminal 10 and the external system 46 occur through input/output (I/O) circuit 56, which can include any suitable bus technologies, such as an AGTL+ frontside bus and a PCI backside bus. Although the I/O circuit 56 is shown as a single block, it should be appreciated that the I/O circuit 56 alternatively includes a number of different types of I/O circuits. Furthermore, in some embodiments, the components of the gaming terminal 10 can be interconnected according to any suitable interconnection architecture (e.g., directly connected, hypercube, etc.).

The I/O circuit 56 is connected to an external system interface or communication device 58, which is connected to the external system 46. The controller 42 communicates with the external system 46 via the external system interface 58 and a communication path (e.g., serial, parallel, IR, RC, 10bT, near field, etc.). The external system 46 includes, in various aspects, a gaming network, other gaming terminals, a gaming server, a remote controller, communications hardware, or a variety of other interfaced systems or components, in any combination. In yet other aspects, the external system 46 may comprise a player's portable electronic device (e.g., cellular phone, electronic wallet, etc.) and the external system interface 58 is configured to facilitate wireless communication and data transfer between the portable electronic device and the controller 42, such as by a near field communication path operating via magnetic field induction or a frequency-hopping spread spectrum RF signals (e.g., Bluetooth, etc.).

The gaming terminal 10 optionally communicates with external system 46 (in a wired or wireless manner) such that each terminal operates as a “thin client” having relatively less functionality, a “thick client” having relatively more functionality, or with any range of functionality therebetween (e.g., an “intermediate client”). In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external systems 46 (“thin client” gaming terminal), or are distributed therebetween in any suitable manner (“intermediate client” gaming terminal).

Referring now to FIG. 3, a thermal management system 300 according to one aspect of the present invention is shown within a cabinet 312 of a gaming terminal. The gaming terminal can be of the same type and form as the gaming terminal 10 described above with respect to FIGS. 1-2.

Here, the top, front, and right side surfaces of the cabinet 312 are omitted for easier viewing. A gaming terminal component 315 (e.g., a CPU, controller or hard disk memory) is shown on the bottom surface of the cabinet 312 to facilitate an operational description of the thermal management system 300. As explained above, many additional gaming terminal components (e.g., primary displays, secondary displays, money/credit detectors, information readers, player input-output devices, ticket printers, audio speakers, player accessible portions, communication boards, system memories, controllers, etc.) are also mounted on or located within the cabinet 312. It is to be understood that the various gaming terminal components are located at a plurality of different locations within the cabinet 312. Some components such as, for example, CPUs, controllers, communication boards, system memory and the like are often located on the bottom surface of the cabinet 312, in part, to avoid suspended mountings and to permit warm air to rise away from such components. Other components such as, for example, video displays, audio systems, player input devices and the like are often mounted in elevated locations within the cabinet 312 in order to better serve the intended purpose of such components (e.g., a video display is often located at eye level of a player).

During operation, the gaming terminal components (e.g., the gaming terminal component 315) generate heat, warming the air in proximity to the gaming terminal components. The thermal management system 300 uses air flow principles according to the Venturi effect and the Chimney effect to efficiently exhaust heated air from the cabinet 312 and draw cooler air into the cabinet 312.

The thermal management system 300 includes a vertical air duct 320 having an intake port 322 and an outtake port 324. The intake port 322 comprises an opening at a bottom end of the air duct 320 positioned and configured to permit heated air from inside the cabinet 312 to enter into the air duct 320. The heated air can be allowed to naturally flow into the intake port 322 or the heated air can be pushed into the intake port 322 (e.g., via one or more fans disposed in proximity to the intake port 322). Locating the gaming terminal component 315 near the intake port 322 can facilitate ingress of heated air into the intake port 322 as some gaming terminal components (e.g., CPUs and power supplies) have built-in fans that can be utilized to force air into the intake port 322.

The outtake port 324 comprises an opening at a top end of the air duct 320 positioned and configured to exhaust heated air out of the cabinet 312. Accordingly, the cabinet 312 includes an opening or vent (not shown) located and configured to allow air to exhaust out of the cabinet 312 via the outtake port 324. The illustrated air duct 320 includes a plurality of side walls 326 spanning between the intake port 322 and the outtake port 324, defining an air passageway. Because warm air rises, the heated air entering the intake port 322 will flow upwards through the air duct 320 and exit the cabinet 312 after exiting the outtake port 324. It is contemplated that the outtake port 324 can be located and configured such that the heated air is directed out of the top of the cabinet 312 and away from the vicinity of a player.

The air duct 320 further includes a vent 328 within one of the side walls 326 between the intake port 322 and the outtake port 324. The vent 328 is configured to draw additional air into the air duct 320 as a result of air flow principles and without mechanical assistance (e.g., as a result of the Venturi Effect). For example, the vent 328 illustrated in FIG. 3 includes a vent opening 330 in one of the side walls 326 and a bottom flap 332 extending into the passageway of the air duct 320. The bottom flap 332 obstructs a portion of the passageway within the air duct 320, effectively constricting the size of the passageway at the vent 328. As heated air flows through the constriction in the air duct 320, the air flow velocity increases to satisfy the equation of continuity and the air pressure decreases due to conservation of energy. This is known as the Venturi Effect. This decrease in pressure at the vent 328 draws additional air into the air duct 320 from the cabinet 312 through the vent opening 330. Optionally, a top flap 334 can be provided above the vent 328 to help capture air inside the cabinet 312 and direct it upwards into the air duct 320 with reduced air turbulence.

A portion of the air that is heated by the gaming component 315 at the bottom of the cabinet 312 may not enter the intake port 322 of the air duct 320. This uncaptured heated air nonetheless rises and accumulates within the upper portions of the cabinet 312. Additionally, a number of gaming terminal components are often located at elevated locations within the cabinet 312 (e.g., a video display is often located within the cabinet so as to be at a player's eye level). These components may also heat the air in the upper portions of the cabinet 312. By appropriately locating the vent 328 or vents 328 along the air duct 320, heated air in the upper portions of the cabinet 312 can be drawn into the air duct 320 through the vent 328 or vents 328 and can be exhausted from the cabinet 312 through the outtake port 324. Advantageously, the vent 328 can be located in close proximity to any gaming terminal components mounted in elevated positions within the cabinet 312.

As heated air exhausts out of the cabinet 312, new air needs to enter the cabinet 312. A cabinet opening 336 is provided near or at the bottom surface of the cabinet 312. The cabinet opening 336 allows new cooler air to enter the cabinet 312 from the environment outside the cabinet 312 (e.g., as a result of the Chimney Effect). As the components of the gaming terminal become warmer, the air flow will increase under natural convection. This increase will draw additional cooler air into the cabinet 312 through the cabinet opening 336 to maintain a cool temperature inside the cabinet 312. While the cabinet opening 336 is shown in the bottom surface of the cabinet 312 and spaced away from the intake port 322, it should be understood that the cabinet opening 336 can be located at other positions in the bottom surface of the cabinet 312 and/or on other side walls of the cabinet 312. Additionally, it should be understood that additional cabinet openings 336 can be provided to draw air into the cabinet 312 from the environment outside of the cabinet 312.

It is contemplated that the air duct 320 can have other shapes and sizes than those illustrated and described above. For example, the air duct 320 can have a cross-section that is circular, tubular, square, rectangular, polygonal, combinations thereof and/or the like. Similarly, the air duct 320 can be straight, curved, slanted, combinations thereof and/or the like. Furthermore, multiple air ducts 320 can be located within one gaming cabinet 312. The air duct 320 need not be located against the rear surface of the cabinet 312; rather, it can be located in any suitable position within the cabinet 312. The air duct 320 can be made from any suitable material including, for example, wood, metal, plastic, combinations thereof and/or the like. Advantageously, the air duct 320 can be made from a thermally insulating material to resist heat transfer from the air duct 320 to the air surrounding the air duct 320 in the cabinet 312.

While the intake port 322 and the outtake port 324 have been described as openings at the ends of the air duct 320, it is to be understood that the intake port 322 and/or the outtake port 324 can be configured as vents or openings in the side of the air duct 320. Accordingly, the air duct 320 could be enclosed at its topmost and/or bottommost ends.

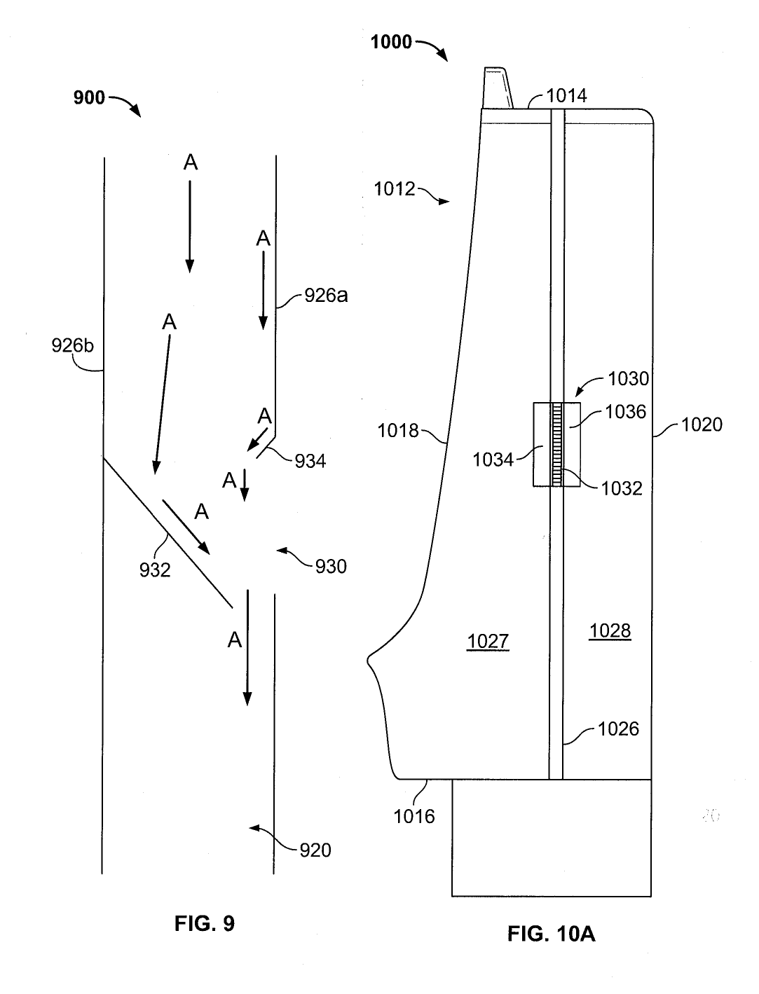

While the air duct 320 of the thermal management system 300 has been illustrated and described as having only one vent 328, it is to be understood that any other number of vents 328 can be provided within the air duct 320. Further, it is contemplated that the vent(s) 328 can have any other suitable configuration for drawing air into the air duct 320 due to the Venturi Effect. For example, the vent 328 can be comprised of a first flap extending into the air-flow passageway connected to a second flap extending upwards within the air-flow passageway. An additional vent configuration is discussed in further detail below with respect to FIG. 9.

According to alternative aspects, a vent is also provided in proximity to the intake port to facilitate ingress of heated air into the air duct. Referring to FIG. 4, a thermal management system 400 and a gaming terminal component 415 are shown within a cabinet 412. The top, front, and right side surfaces of the cabinet 412 are omitted for easier viewing. The thermal management system 400 includes an air duct 420 having an intake port 422, an outtake port 424 and a plurality of side walls 426 spanning the intake port 422 and the outtake port 424 to define an air passageway. The air duct 420 includes an upper vent 428 that is configured to draw air into the air duct 420 due to the Venturi Effect as describe above with respect to the vent 328 of the thermal management system 300 illustrated in FIG. 3.

The air duct 420 further includes a lower vent 440. The lower vent 440 is located in one of the side walls 426 near the intake port 422. Air heated by the gaming terminal component 415 flows into or is forced into the lower vent 440. For example, a built-in fan (not shown) on the gaming terminal component 415 can be used to force air toward or into the lower vent 440. A flap 441 can be provided above the lower vent 440 to guide air from the gaming terminal component 415 into the lower vent 440. While a flap 441 is shown, it is to be understood that any other suitable structure or configuration can be provided for guiding air from the gaming component 415 into the lower vent 440. Accordingly, the flap 441 can be specifically designed to have a unique configuration corresponding to the type and configuration of gaming terminal component 415 from which the flap 441 is guiding air into the air duct 420.

After entering the air duct 420 through the lower vent 440, the heated air rises. The resulting updraft within the air duct 420 pulls additional air into the air duct 420 through the air intake port 422. Accordingly, greater amounts of air are drawn into the air duct 420 and increased efficiency can be achieved when an lower vent 440 is provided in proximity to the intake port 422. The heated air flows upwards within the air duct 420, through the constriction at the upper vent 428 (drawing additional air into the air duct 420), and finally exhausts out of the cabinet 412 via the outtake port 424.

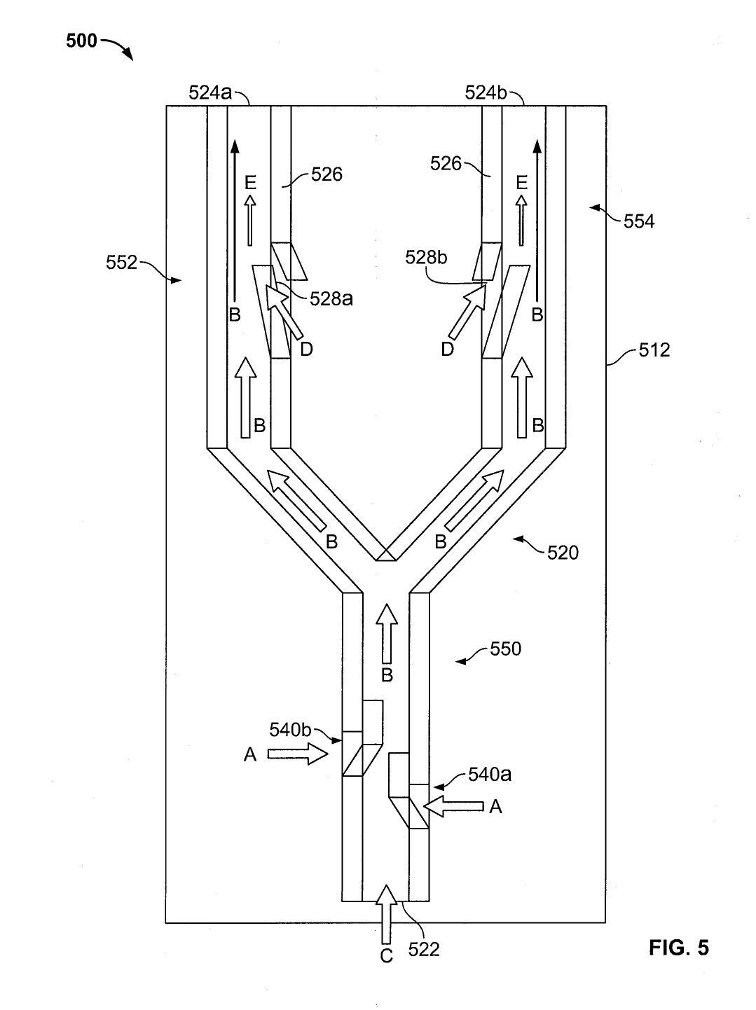

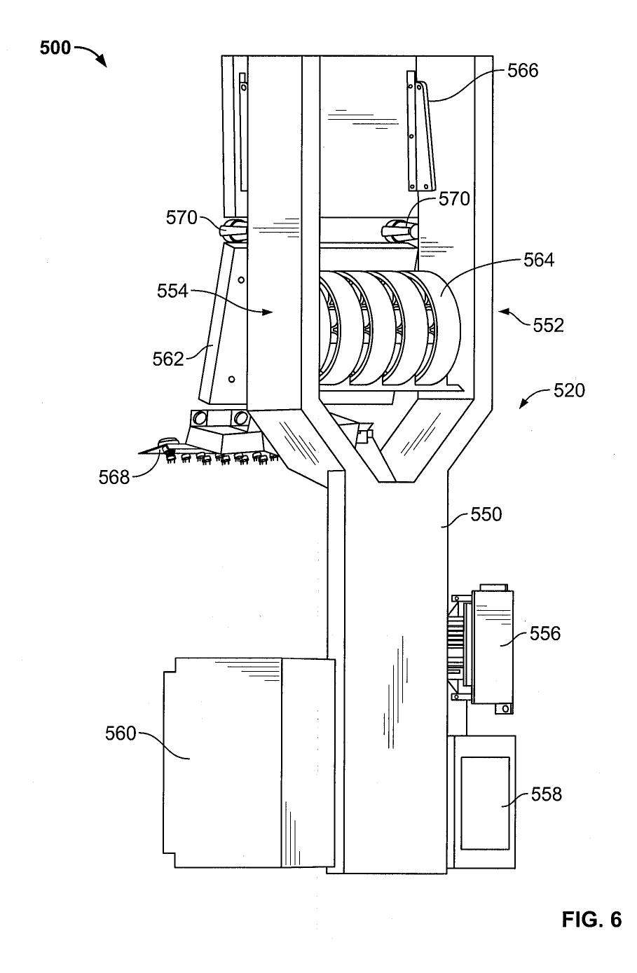

Referring now to FIGS. 5-6, a thermal management system 500 according to alternative aspects of the present invention is shown in a cabinet 512. The thermal management system 500 includes an air duct 520 having a lower portion 550, a first upper portion 552 and a second upper portion 554 in a Y-shaped configuration. The air duct 520 includes an intake port 522 at the bottom of the lower portion 550, and two outtake ports 524a, 524b at the top of the first and second upper portions 552, 554, respectively. Two lower vents 540a, 540b are provided in opposing side walls 526 of the lower portion 550 of the air duct 520. Two upper vents 528a, 528b are provided in opposing inner side walls 526 of the first upper portion 552 and the second upper portion 554 of the air duct 520.

FIG. 6 shows various gaming terminal components positioned in relation to the air duct 520. It is to be understood that the illustrated components of the gaming terminal are intended to be exemplary; many additional and/or different components of the gaming terminal can be disposed within the cabinet 512. Additionally, it is to be understood that many of the illustrated gaming terminal components can be disposed in locations relative to the air duct 520 and the cabinet 512 that are different than those locations shown in FIG. 6.

A CPU 556, a system memory 558, and a power supply 560 are disposed adjacent the lower vents 540a, 540b in the lower portion 550 of the air duct 520. A transmissive display 562, a plurality of mechanical reels 564, a secondary display 566, a player input device 568, and an audio system 570 are disposed at an elevated position within the cabinet 512. Advantageously, the Y-shaped configuration of the air duct 520 can be configured to permit one or more of the elevated gaming terminal components to be disposed between the upper vent 528a in the first upper portion 552 and the upper vent 528b in the second upper portion 554. For example, the mechanical reels 564 (and their motors) are disposed between the upper vent 528a in the first upper portion 552 and the upper vent 528b in the second upper portion 554. It will be appreciated that the other elevated gaming terminal components are also within close proximity to one or both of the upper vents 528a, 528b such that heated air generated by such components is more likely to be drawn into the upper vents 528a, 528b and exhausted from the cabinet 512. One or more flaps can be provided to guide air flow into the upper vents 528a, 528b from gaming terminal components located within close proximity to the upper vents 528a, 528b. An additional benefit to such a configuration is that the air duct 520 can be used to assist in mounting gaming terminal components within the cabinet 512. The first upper portion 552 and the second upper portion 554 can have different dimensions than the lower portion 550 so as to provide greater structural support or venting of the components mounted in elevated positions.

Referring to FIG. 5, air heated by the gaming terminal components is allowed to flow into or is forced into the lower vents 540a, 540b as shown by Arrows A. The heated air rises within the air duct 520 as shown by Arrows B. The updraft near the lower vents 540a, 540b draws additional heated air into the intake port 522 as indicated by Arrows C. At the upper vents 528a, 528b, the passageway of the air duct 520 is constricted. As the heated air passes through the constrictions, the rate of air flow accelerates and the air pressure decreases at the opening of the upper vents 528a, 528b according to the Venturi Effect. The decreased air pressure draws additional air into the air duct 520 through the upper vents 528a, 528b as indicated by Arrows D. The heated air in the air duct 520 continues to rise until it is finally exhausted out of the cabinet 512 via the outtake ports 524a, 524b as indicated by Arrow E.

One benefit to the thermal management system 300, 400, 500 is that no additional cabinet fans (i.e., no fans in addition to those that are built-in to various gaming terminal components) are required to sufficiently exhaust heated air from the cabinet. This is known as a passive thermal management system. However, although not required, additional cabinet fans can be located at the top or the bottom of the cabinet or within the air duct to aid in maintaining sufficient air flow to sustain the Venturi Effect and/or the Chimney Effect. This is known as an active thermal management system. An additional benefit is that fans at the bottom of the cabinet would be subjected to reduced temperatures prolonging the lifespan of such fans. It is contemplated that the cabinet fans can be powered by any suitable power supply such as, for example, an external power supply, a solar power cell on the exterior of the cabinet, combinations thereof or the like. It is further contemplated that a solar powered fan can be provided near the outtake port to increase airflow.

Wagering game terminals are highly regulated devices, which must meet a number of requirements to operate in casinos. One requirement is that a wagering game terminal must be able to withstand exposure to liquids without certain negative or hazardous consequences. One test that wagering game terminals are subjected to involves pouring one liter of water for a duration of one minute over the external surface of the gaming terminal to verify that no water reaches the internal components that contain hazardous voltages. Another test involves pouring 0.25 liters of water at or into any openings of a wagering game terminal to verify that no water reaches the internal components that contain hazardous voltages.

As explained above, the thermal management systems described and illustrated above in FIGS. 3-6 generally include an opening in the cabinet for exhausting air out of an air duct via an outtake port. Water poured over the exterior of a gaming terminal could enter this opening and flow down the air duct. As explained above, the air duct includes one or more vents and/or intake ports which could allow water to access the gaming terminal components within the cabinet. As such, modifications can be made to the thermal management systems described above to prevent or minimize such risks and meet regulatory requirements.

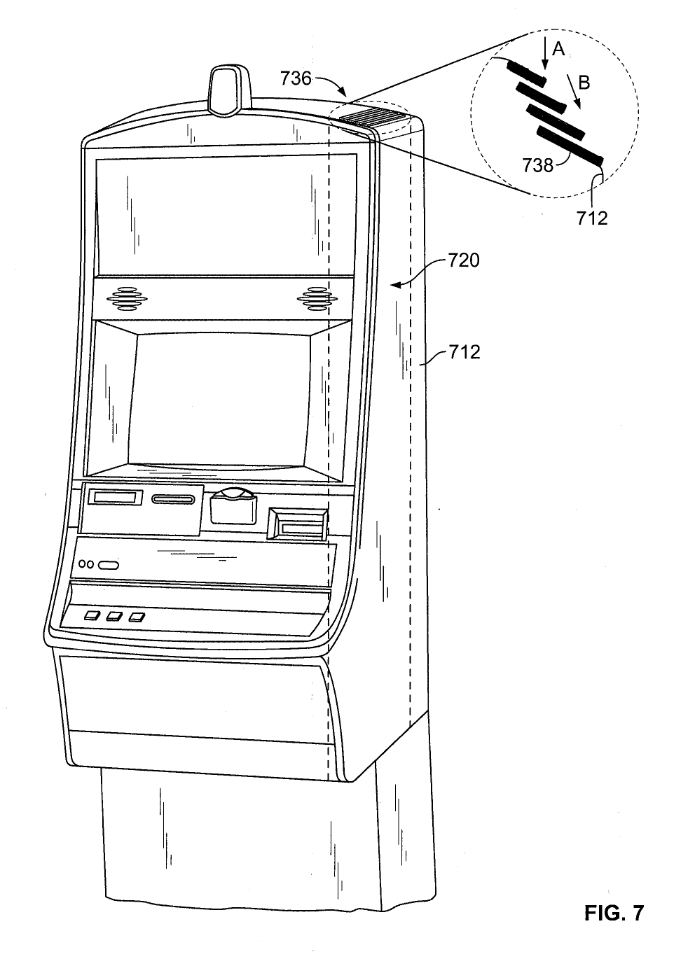

According to one modification, a cap or other structure can be provided above the opening(s) in the cabinet through which air is exhausted from the air duct. Referring to FIG. 7, a cabinet 712 is shown having an opening 736 in the cabinet 712 for exhausting air from an air duct 720. The opening 736 comprises a grating having a plurality of slats 738. The plurality of slats 738 are disposed so as to be spaced vertically from one another. Further, the plurality of slats 738 are orientated at an angle and overlap in a horizontal direction such that water poured onto the slats 738 passes over the surface of the slats 738 and away from the opening 736. For example, water poured onto the opening in the direction of Arrow A is directed by the slats 738 in the direction of Arrow B away from the opening 736. While water can only flow in the direction of the slats 738, heated air is not so restricted. Thus, heated air is still able to exhaust from the air duct 720 out of the cabinet 712 via the vertical spacings between adjacent slats 738.

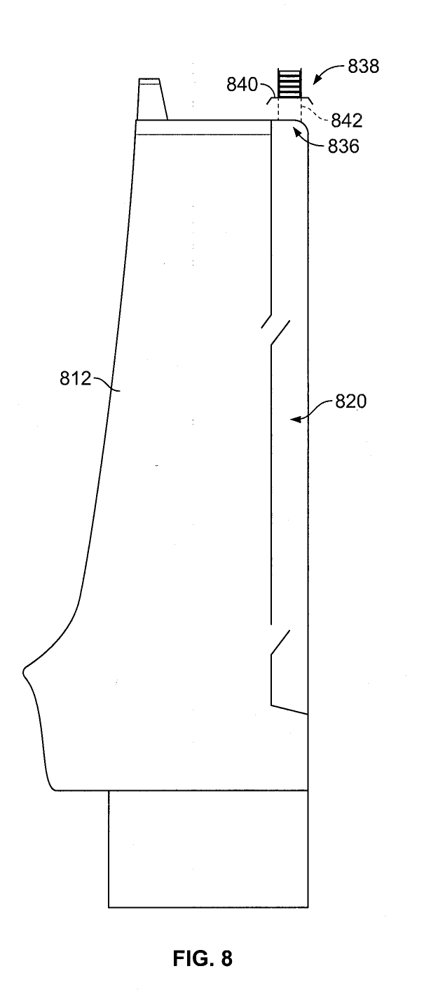

Referring to FIG. 8, a cabinet 812 is shown having an opening 836 in the cabinet 812 for exhausting air from an air duct 820. The cabinet 812 further includes a cap 838 mounted above the opening 836 by one or more supports 842 such that there is a gap(s) between the opening 836 and the cap 838. The cap 838 includes a surface 840 that is configured to direct water away from the opening 836. The surface 840 can be configured as a level surface, a slanted surface, a rounded surface, combinations thereof and/or the like. Water is inhibited from entering the opening 836 by the surface 840 while heated air is able to exhaust from the air duct 820 out of the cabinet 812 via the gap(s) between the surface 840 and the cabinet 812.

Referring to FIG. 9, an alternative configuration for a vent 900 of an air duct 920 is shown. The air duct 920 provides an air passageway defined by four side walls including a side wall 926a and a side wall 926b. The vent 900 includes a vent opening 930, a drip lip 934 and a back flap 932. The drip lip 934 extends down and inwards from the side wall 930a above the opening 930. The back flap 932 extends down and inwards from the side wall 930b opposite the opening 930. Accordingly, water poured down the air duct 920 will flow according to the Arrows A and will not enter the cabinet 912 interior through the vent opening 930. It is to be understood that the vent 900 can be any vent (e.g., lower vent or upper vent operating according to Venturi Effect) within the air ducts described above with respect to FIGS. 3-6. Additionally, it is to be understood that other configurations for the vents may be provided to direct water flowing down the air duct away from the vent openings.

However, even if water passing through an air duct does not enter the cabinet through the various vents, the water may still enter through the intake port at the bottom of the air duct in the thermal management systems described and illustrated above with respect to FIGS. 3-6. Accordingly, an intake port (or bottom) of an air duct can be modified to channel water out of a cabinet. For example, an air duct can have an intake port that terminates at the bottom surface of a cabinet. A cabinet opening is provided in the bottom surface of the cabinet in communication with the intake port. As such, water flowing down the air duct exits the cabinet via the intake port in communication with the cabinet opening. According to an alternative aspect, an intake port (or bottom) of an air duct can be connected to a tube that channels water outside of the cabinet.

According to another aspect of the present invention, the cabinet is bifurcated into separate chambers, one chamber for housing the components of the gaming terminal and another chamber for ventilating heated air from the cabinet. The heat generated by the gaming terminal components in the first chamber is transferred to the second chamber and ventilated out of the cabinet. The air circulated within the first chamber does not mix with the air circulating within the second chamber.

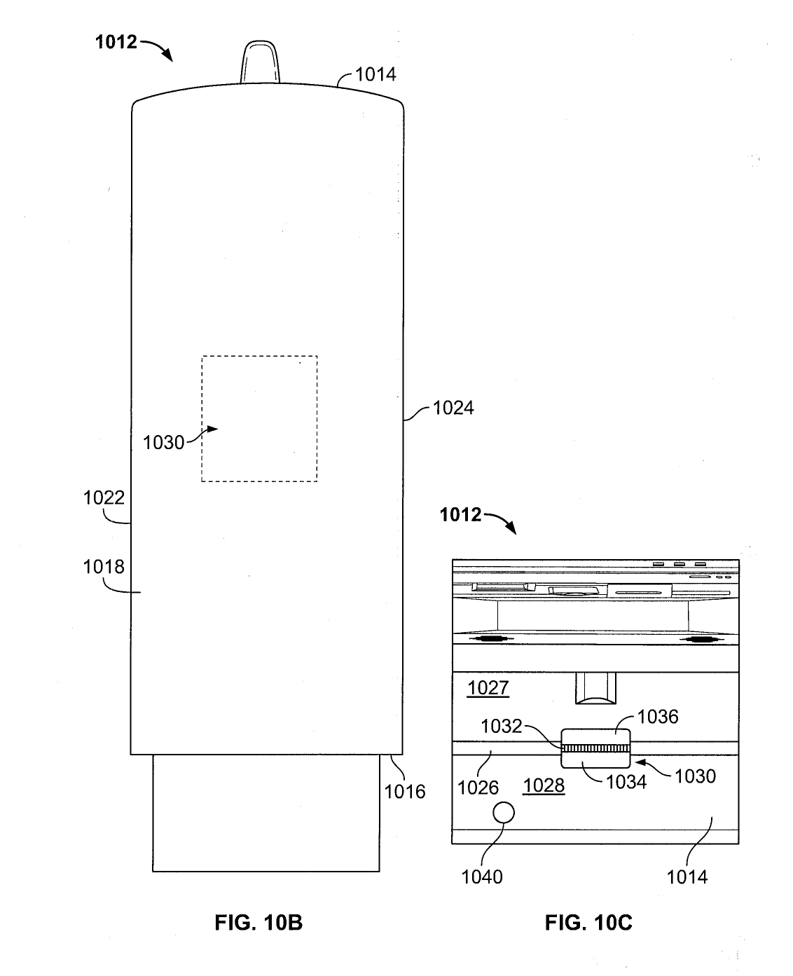

FIG. 10A is a side view, FIG. 10B is a rear view, and 10C is a top view of a thermal management system 1000 and a cabinet 1012. The cabinet 1012 may be any type of enclosed structure utilized in gaming terminals. Here, the cabinet 1012 comprises a top wall 1014, a bottom wall 1016, a front wall 1018, a rear wall 1020, a left side wall 1022 and a right side wall 1024 interconnected to define an interior space of the cabinet 1012. The cabinet 1012 further includes an interior wall 1026 that divides the interior space of the cabinet 1012 into a first chamber 1027 and a second chamber 1028. The interior wall 1026 includes a thermoelectric cooler assembly 1030 for transferring heat from the first chamber 1027 to the second chamber 1028.

The thermoelectric cooler assembly 1030 comprises a thermoelectric device 1032 disposed between a first heat sink 1034 and a second heat sink 1036. The thermoelectric cooler assembly 1030 is inserted into the interior wall 1026 such that the thermoelectric device 1032 is substantially coincident with the interior wall 1026, the first heat sink 1034 is disposed within the first chamber 1027, and the second heat sink 1036 is disposed within the second chamber 1028. The interior wall 1026 can be comprised of a thermal insulating material to resist heat transfer between the first chamber 1027 and the second chamber 1028, except via the thermoelectric cooler assembly 1030.

The thermoelectric device 1032 comprises any device suitable to operate in accordance with the Peltier effect. When an electric current is applied to the thermoelectric device 1032, heat is absorbed by one side of the thermoelectric device 1032. The absorbed heat is passed to and dissipated by the other side of the thermoelectric device 1032. Whether a particular side of the thermoelectric device 1032 absorbs or dissipates heat is determined by the direction of current flow through, or voltage polarity applied to, the thermoelectric device 1032. Accordingly, the electric current and/or the voltage polarity applied to the thermoelectric device 1032 is such that heat is absorbed on the side of the thermoelectric device 1032 facing the first chamber 1027 and heat is dissipated on the side of the thermoelectric device 1032 facing the second chamber 1028. An example of a suitable commercially available thermoelectric device is the INB product line manufactured by Watronix Inc., which is currently headquartered at 8376 Samra Drive, West Hills, Calif. 81304.

The first heat sink 1034 and the second heat sink 1036 are coupled to opposing sides of the thermoelectric device 1032 to assist in removing heat from, or dissipating heat to, the adjacent environment of the first chamber 1027 and the second chamber 1028, respectively. Being disposed within the first chamber 1027, the first heat sink 1034 is in thermal communication with the air within the first chamber 1027. Similarly, the second heat sink 1036 is in thermal communication with the air within the second chamber 1028. Heat transferred to the air in the first chamber 1027 by components of the gaming terminal is absorbed by the first heat sink 1034. The thermoelectric device 1032 transfers this heat to the second heat sink 1036. The second heat sink 1036 dissipates the heat into the air within the second chamber 1028. One or more exhaust openings 1040 are provided within the cabinet wall(s) (e.g., the top wall 1014 of the cabinet 1012) to exhaust the heated air out of the second chamber 1028 of the cabinet 1012.

The first heat sink 1034 and the second heat sink 1036 are generally rectangular in shape and constructed of a thermally conductive material (e.g., copper); however, it is contemplated that the heat sinks 1034, 1036 can have any other suitable shape and size (e.g., circular, oval, triangular, square, polygonal, combinations thereof and/or the like). To enhance thermal transfer efficiency, the exterior surface of the first heat sink 1034 and the second heat sink 1036 can include a plurality of fins extending along longitudinal axes of the first heat sink 1034 and the second heat sink 1036. The plurality of fins define channels such that air can traverse the channels to be cooled or heated by the exterior surface of the first heat sink 1034 or the second heat sink 1036. The number, spacing, height and orientation of the fins are selected to achieve maximum air circulation within the first chamber 1027 and/or the second chamber 1028.

Optionally, one or more fans (not shown) can be provided within the first chamber 1027 and/or the second chamber 1028 to further enhance thermal transfer efficiency. The fans can be configured to direct air over the surface of the first heat sink 1034 and/or the second heat sink 1036. The fans can alternatively be configured to circulate air between the gaming terminal components and the first heat sink 1034 within the first chamber 1027, or between the second heat sink 1036 and the exhaust opening(s) 1040 in the cabinet 1012.

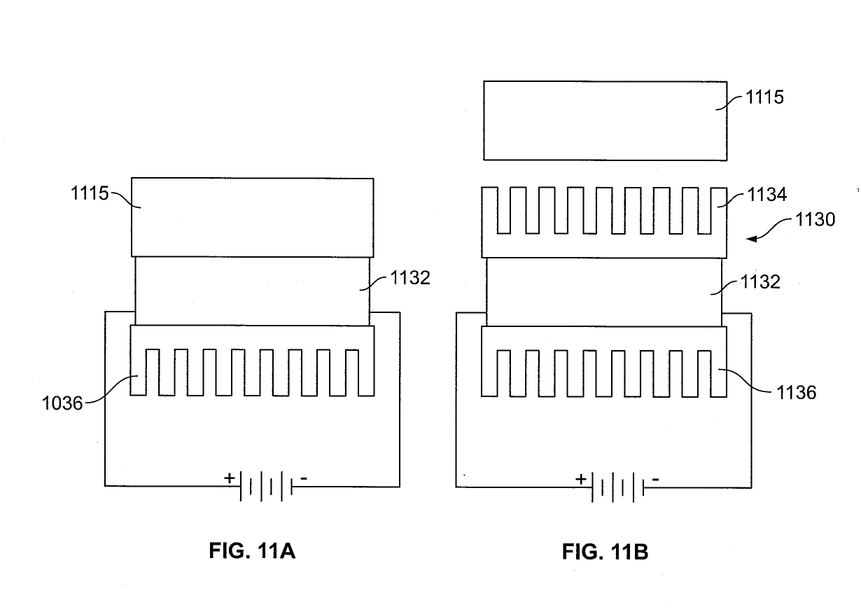

Any number of thermoelectric cooler assemblies 1030 can be installed in the cabinet 1012. The number, location, size and configuration of the thermoelectric cooler assemblies 1030 can be selected in accordance with the number, type, and location of the gaming terminal devices within the first chamber 1027. It is contemplated that the gaming terminal components can be in direct contact with the thermoelectric device 1032 or the heat sinks in the first chamber 1027 and/or the gaming terminal components can be spaced apart from the heat sinks in the first chamber 1027. For example, FIG. 11A shows a thermoelectric device 1132 directly coupled to a gaming terminal component 1115 on one side and a second heat sink 1136 on the other side, and FIG. 11B shows a thermoelectric cooler assembly 1130 (comprising a first heat sink 1134, a thermoelectric device 1132, and a second heat sink 1136) spaced apart from a gaming component 1115. Advantageously, the thermoelectric cooler assembly 1130 can be disposed near the air intake (not shown) of a gaming terminal component 1115 so that cooler air is passed through the gaming terminal component 1115 by a fan built into the gaming terminal component. Additionally, it is contemplated that the thermoelectric cooler assemblies 1030 can be any device having thermodynamic characteristics capable of transferring thermal energy between the first heat sink 1034 and the second heat sink 1036.

A thermostat system can be provided within the cabinet 1012 for controlling the temperature within the first chamber 1027. The thermostat system includes one or more temperature sensors disposed within the first chamber 1027 in electrical communication with a controller unit. The controller unit uses signals received from the temperature sensors to control the thermoelectric cooler assembly 1030 (and/or fans). A desired temperature or desired temperature range is programmed into the controller. When the first chamber 1027 exceeds the desired temperature or desired temperature range, the controller directs the thermoelectric cooler assembly 1030 to cool the first chamber 1027. The rate of heat transfer is controlled by the number of thermoelectric cooler assemblies (if applicable) that are switched on and the current flow that is provided to each thermoelectric cooler assembly. The temperature sensor(s) may be implemented by an RTD thermocouple or any other temperature sensor capable of proving temperature signals to the controller.

Additionally, the thermostat system can control the amount of cooling so as prevent or inhibit condensation within the cabinet 1012. It is contemplated that this can be achieved with the temperature sensors and/or one or more sensors specifically dedicated to detecting condensation within the first chamber 1027 or on any of the gaming terminal components. Inhibiting condensation buildup keeps potentially disruptive and harmful moisture away from the gaming terminal components and also prevents rusting of any metal within the first chamber 1027.

It is contemplated that a condensation management system can be provided within the first chamber 1027 to further mitigate condensation. For example, a drip plate can be provided below the thermoelectric cooler assembly 1030 to receive condensation falling from the thermoelectric cooler assembly 1030. The drip plate can include a channel for directing accumulated condensation out of the cabinet 1012. Alternatively, a desiccant can be provided in the drip plate to absorb condensation falling from the thermoelectric cooler assembly 1030. The drip plate including a desiccant could be periodically replaced as necessary.

There are several advantages to the thermal management system 1000 described above. Because the thermoelectric device is solid state device, the thermoelectric cooler assembly has no moving parts and is exceptionally reliable. Additionally, the number of direct interior access ventilation holes in the cabinet 1012 can be reduced and no smoky, dusty casino air is drawn over sensitive digital circuits of the gaming terminal components to cool them. While some air from the environment surrounding the cabinet 1012 may leak into the first chamber (e.g., via cracks in the access doors, input devices, etc.), the first chamber can be substantially isolated from the environment surrounding the gaming terminal cabinet 1012.

Also, the junction between the interior wall and the surrounding walls can be sealed and waterproofed with, for example, rubber, silicone or the like. As such, no water or other liquids that may be poured through the exhaust opening 1040 in the second chamber 1028 can reach the gaming terminal components within the first chamber 1022.

It is to be understood that the various aspects described above can be combined within one cabinet of a gaming terminal. For example, a thermal management system could include one or more vents and one or more thermoelectric cooler assemblies disposed along an air duct. Accordingly, heated air enters or is drawn into the air duct via the vent(s), while the thermoelectric cooler assembly(s) also transfers heat from the cabinet interior into the air duct. Disposing the “hot side” of the thermoelectric cooler assembly within the air duct further heats the air within the air duct, which leads to greater air flow.

While numerous configurations are possible, it is contemplated that according to one configuration the thermoelectric cooler assemblies are directly coupled to the gaming terminal components that generate the most heat while the other gaming terminal components are cooled by air flow. According to some aspects, the thermoelectric cooler assembly(s) can be disposed near the vent(s) and/or intake port(s).

Each of these embodiments and obvious variations thereof is contemplated as falling within the spirit and scope of the claimed invention, which is set forth in the following claims.

What is claimed is:

1. A gaming terminal for playing a wagering game, comprising:
a game cabinet containing an electronics component used in conjunction with the wagering game, the electronics component producing heat; and
an air duct located within the cabinet and defining an air-flow passageway, the air duct having an intake port, an outtake port, and at least one first vent between the intake port and the outtake port, the intake port being configured to receive air into the air duct, the outtake port being configured to exhaust air out of the game cabinet, the first vent receiving air heated by the electronics component.

2. The gaming terminal of claim 1, wherein the heated air is received in the first vent as a result of the Venturi Effect.

3. The gaming terminal of claim 2, wherein the air-flow passageway is constricted near the first vent.

4. The gaming terminal of claim 1, wherein the air duct includes a second vent between the intake port and the outtake port at a location that is different from the first vent, the second vent being configured to receive heated air into the air duct.

5. The gaming terminal of claim 4, wherein the second vent is further configured such that an updraft is generated when air is received into the air duct via the second vent and the updraft has a sufficient force to cause air to be drawn into the air duct through the intake port.

6. The gaming terminal of claim 1, further comprising a flap extending from the first vent to the electronics component to guide air from the electronics component into the air duct through the first vent.

7. The gaming terminal of claim 6, wherein the electronics component includes a built-in fan, and the flap extends from a position above the first vent to a position above the built-in fan of the electronics component.

8. The gaming terminal of claim 1, wherein the air duct comprises a lower portion, a first upper portion and a second upper portion in a Y-shaped configuration, the first upper portion including the outtake port, the second upper portion including a second outtake port configured to exhaust air out of the game cabinet.

9. The gaming terminal of claim 8, wherein the at least one first vent includes a first lower vent, a second lower vent, a first upper vent and a second upper vent, the first lower vent and the second lower vent being provided in the lower portion of the air duct, the first upper vent being provided in the first upper portion of the air duct, and the second upper vent being provided in the second upper portion of the air duct.

10. The gaming terminal of claim 1, further comprising one or more fans disposed within the cabinet to force air into the air duct.

11. The gaming terminal of claim 1, further comprising a fan disposed within the air duct to increase air flow through the air-flow passageway.

12. The gaming terminal of claim 1, wherein the heated air is only passively received into the air duct.

13. The gaming terminal of claim 1, wherein the air duct includes a water-control system adjacent to the first vent, the water-control system includes internal structures within the air passageway that direct downwardly falling water past the at least one first vent to inhibit the water from exiting the air duct through the at least one first vent.

14. The gaming terminal of claim 13, wherein the intake port is configured to direct water out of the cabinet.

15. The gaming terminal of claim 1, wherein the cabinet includes an opening for exhausting air out of the cabinet through the outtake port and a structure disposed above the opening to inhibit the flow of water from entering the air duct.

16. The gaming terminal of claim 15, wherein the structure disposed above the opening is a grating including a plurality of slats, the plurality of slats being configured to direct downwardly falling water away from the opening.

17. The gaming terminal of claim 15, wherein the structure disposed above the opening is a cap, the cap being spaced above the opening such that a gap exists between the cap and the opening, the cap including a surface configured to direct downwardly falling water away from the opening.

18. The gaming terminal of claim 1, wherein the air duct is fabricated from a thermal insulating material.

19. The gaming terminal of claim 1, wherein the cabinet includes an opening near the bottom of the cabinet, air from an environment outside of the cabinet being drawn into the cabinet through the opening as a result of the upward movement of the air within the air-flow passageway.

20. The gaming terminal of claim 1, further comprising at least one thermoelectric assembly disposed adjacent to the air duct, the at least one thermoelectric assembly transferring the heat from the electronics component into the air duct.

21. The gaming terminal of claim 20, wherein the at least one thermoelectric assembly comprises at least one thermoelectric cooler, a first heat sink, and a second heat sink, the first heat sink and the second heat sink being coupled to the at least one thermoelectric cooler, the first heat sink being at least partially disposed outside of the air duct, and the second heat sink being at least partially disposed within the air duct.

22. A gaming terminal for playing a wagering game, comprising:
a game cabinet;
an interior wall within the cabinet dividing the cabinet into a first chamber and a second chamber, the first chamber containing an electronics component used in conjunction with the wagering game, the electronics component producing heat; and
at least one thermoelectric assembly disposed adjacent to the interior wall, the at least one thermoelectric assembly being configured to transfer heat from the first chamber to the second chamber.

23. The gaming terminal of claim 22, wherein the at least one thermoelectric assembly comprises at least one thermoelectric device operating according to the Peltier Effect.

24. The gaming terminal of claim 23, wherein the at least one thermoelectric assembly includes a first heat sink and a second heat sink coupled to the at least one thermoelectric device, the first heat sink being at least partially disposed within the first chamber, and the second heat sink being at least partially disposed within the second chamber.

25. The gaming terminal of claim 24, wherein the first heat sink and the second heat sink have a plurality of fins disposed on an exterior surface of the first heat sink and the second heat sink.

26. The gaming terminal of claim 22, further comprising one or more fans within the first chamber, the second chamber, or both the first chamber and the second chamber.

27. The gaming terminal of claim 22, further comprising a thermostat system configured to maintain the first chamber within a desired temperature range, the thermostat system including one or more temperature sensors and a controller, the controller being in electrical communication with the at least one thermoelectric assembly, the controller controlling the electrical current or voltage applied to the at least one thermoelectric assembly to maintain the first chamber within a desired temperature range.

28. The gaming terminal of claim 22, wherein the at least one thermoelectric assembly is in direct contact with one or more heat generating components of the gaming terminal.

29. The gaming terminal of claim 22, wherein an airtight seal is provided between the first chamber and the second chamber such that air is unable to flow between the first chamber and the second chamber.

30. The gaming terminal of claim 22, wherein a fluid impervious seal is provided between the first chamber and the second chamber such that fluid is unable to pass between the first chamber and the second chamber.

31. The gaming terminal of claim 22, wherein the cabinet in the region of the first chamber lacks vents so as to substantially isolate the first chamber from an environment outside of the cabinet.

32. The gaming terminal of claim 22, further comprising a vent disposed in the second chamber to exhaust air from the second chamber to an environment outside of the cabinet.

33. The gaming terminal of claim 32, further comprising one or more fans disposed within the second chamber, the one or more fans being directed towards the vent in the second chamber.

34. A method of cooling electronics within a cabinet of a gaming machine, the cabinet being defined by a plurality of walls and a base floor, the cabinet including an internal duct, the method comprising:
guiding warm air into a first vent within the duct at a location above the base floor of the cabinet, the duct defining an air-flow passageway, the air-flow passageway being shaped to substantially maintain the warm air within the air-flow passageway so as to not permit the warm air to re-enter a region adjacent the electronics;
conveying the warm air upward within the air-flow passageway;
exhausting the warm air from an upper portion of the cabinet; and
while the warm air is exhausting from the cabinet, drawing ambient air that is cooler than the exhausted warm air into a lower portion of the cabinet.

35. The method of claim 34, wherein the guiding warm air into the first vent is facilitated by a flap extending outwardly from the internal duct.

36. The method of claim 35, wherein the warm air is passively guided into the first vent.

37. The method of claim 34, wherein the guiding warm air into the first vent is facilitated by a fan.

38. The method of claim 34, further comprising drawing warm air into a second vent in the internal duct, the second vent at a location that is different from the first vent.

39. The method of claim 38, wherein the warm air is passively drawn into the second vent.

40. The method of claim 38, wherein the air-flow passageway is constricted near the second vent.

41. The method of claim 40, wherein the warm air is drawn into the second vent as a result of the Venturi Effect.

42. The method of claim 38, wherein the guiding warm air into the first vent is facilitated by a flap extending outwardly from the internal duct.
